(19) United States
(12) Patent Application Publication
(10) Pub. No.: US 2006/0164292 A1
(43) Pub. Date: Jul. 27, 2006

(54) Radar system comprising integrated data transmission

(76) Inventors: Josef Buechler, Pfaffenhofen (DE); Juergen Detlefsen, Berg (DE); Uwe Siart, Munich (DE); Michael Wagner, Ulm (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/537,473

(22) PCT Filed: Nov. 28, 2003
(86) PCT No.: PCT/EP03/13446

§ 371 Date: Mar. 16, 2006

(30) Foreign Application Priority Data
Dec. 3, 2002 (DE) 10256620.8

(51) Int. Cl. G01S 13/86

(52) U.S. Cl. 342/52; 342/70; 342/57

(57) ABSTRACT

A radar system includes one or more individual radars, for example for motor vehicles, at least one system of which has both means for sensing and means for transmitting communications data, which means can be operated simultaneously.

The invention relates to a data system with which it is possible both to transmit data for the purpose of communication and to sense for the purpose of sensing the surroundings, a method for operating it and a vehicle which is equipped with this system.

As in the past, even in modem vehicles the drivers are provided with information about the situation in the direct or close surroundings of their vehicle in a mainly visual way. For example, local information and locally applicable traffic rules such as speed limits are communicated to the driver by means of road signs or sign boards, and an imminent braking manoeuvre, for example of the vehicle in front, is also perceived by as a result of the latter's brake lights lighting up (with this information being binary (on/off)). The end of congestion lying up front or some other hazardous location is perceived either directly or by means of the hazard warning lights of the surrounding vehicles. Likewise, information about surrounding locations is also communicated visually, for example by means of sign boards or indicator boards.

As a result, drivers of vehicles in modem traffic are subjected to a large number of optical impressions whose processing often overloads them in many situations, with more or less serious consequences. In order to alleviate this, it is thus desirable to supplement the visual information by means of electronic data; it is advantageous in this context to use information from the direct surroundings of the vehicle, which can be transmitted from vehicle to vehicle. In this context, the data is transmitted where it is generated, consumed and required. In order to implement such a service it is necessary to construct what is referred to as an ad-hoc network whose nodes represent the individual vehicles. One possible procedure for doing this is to use the IEEE 802.11 standard known from WLAN. However, to do this it is necessary to equip the vehicles with the necessary hardware and software components and to adapt these standards to the peculiarities of the motor vehicle. A further possible way of implementing ad-hoc networks is to make advantageous use of the components which are already present in the vehicles. The use of close-range radars as multifunctional sensor systems for comfort and safety functions is currently being increasingly investigated both by vehicle manufacturers and their suppliers. The dual use of a radar system in the vehicle as a surroundings sensing system and data transmission system thus presents one possible solution for the abovementioned requirements. For example, in the German patent application DE 101 58 719, which was published after the priority date of the present application and which also refers back to the applicant, a motor vehicle close-range radar device is described which has a plurality of individual radars which can each be operated individually either in a sensing mode or in a data transmission mode for the purpose of communication. However, this system permits only one individual radar device to be used at a specific time either for transmitting data or for sensing the surroundings. The system which is described in the abovementioned document thus has the disadvantage that when an individual radar device is operated in the data transmission mode it is no longer available for sensing the surroundings. The communications or sensing functionality is thus respectively temporarily not available.

The object of the present invention is thus to specify a device and a method which increases the availability of a combined radar device/data transmission system.

This object is achieved by means of radar systems and their components as well as vehicles having the features described in Claims 1 and 7 to 10 and by the method having the features described in Claim 11. The subclaims present advantageous embodiments and developments of the invention.

In a first advantageous embodiment of the invention the radar system according to the invention is composed of a plurality of individual radars, at least one of which is suitable for ensuring the transmission of data for the purpose of communication at the same time as the sensing mode of the radar transmitter or radar device receiver. In this context it is essential that a carrier frequency from the region of the radar device spectrum used, in particular at approximately 24 GHz or approximately 76 GHz and not, for example, from the frequency ranges used for WLAN systems is used for the transmission of data. In the present invention there is therefore an intentional departure from the conventional practice of avoiding the mutual interference between simultaneous emissions by selecting respectively different frequency ranges for the individual emissions. In this context, the simultaneous use of the individual radar device as a sensing and communications data transmission system has a series of advantages.

Since both the sensing and the transmission of data take place in the same frequency range, the same hardware components, such as, for example, antennas, amplifier stages or filters, can be used for emitting and receiving. Given a suitable selection of the hardware architecture it thus becomes possible to make available the desired bifunctionality of the sensing and transmission of data in an individual radar device by using the corresponding signal processing and conditioning software. This provides the possibility of implementing an additional data transmission functionality in radar systems used in future, for close-range sensing in motor vehicles by means of a software modification with slight hardware adaptations. Furthermore the simultaneous possibility for sensing and transmitting data ensures an efficient use of the individual radar device used without the delay times caused by an alternative use. In addition, the distribution of the individual radars all around the vehicle makes it possible to transmit data selectively in selected directions on the basis of the physical properties of the radar device antennas, for example an emission which provides information about an imminent or beginning braking manoeuvre is appropriate only in the reverse direction.

As a result, in comparison to the systems which are known from the prior art and which operate alternately, the radar system according to the invention provides an increased contribution to the safety of vehicles.

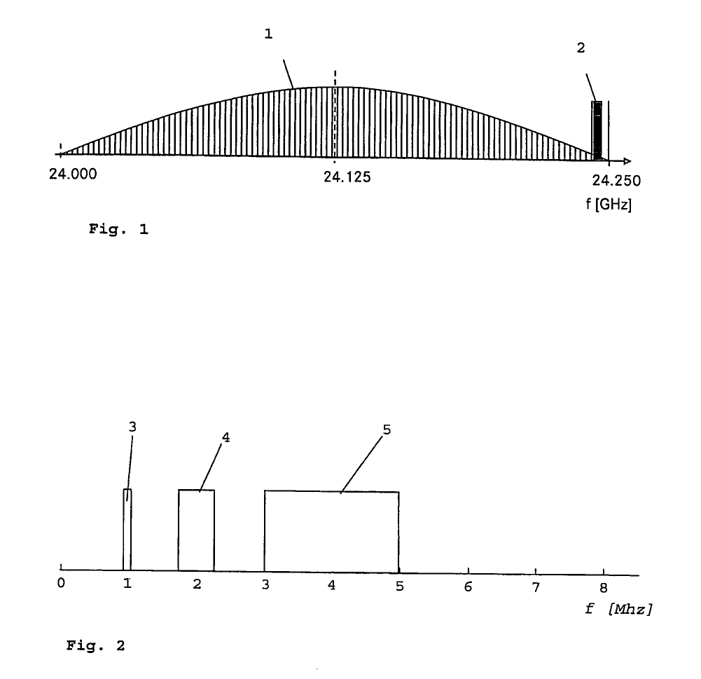

It has proven particularly effective to implement the described functionality in a pulse-type radar device. The pulse-type radar device is operated, for example, at a frequency of approximately 24 GHz. Due to the pulse mode, the transmission/reception spectrum of the radar device exhibits, for example, a bandwidth of 250 MHz; relatively high bandwidths are also conceivable in order to improve the resolution. One qualitative representation of a typical transmission/reception spectrum is illustrated in FIG. 1. As becomes clear from FIG. 1, the envelope of the transmission/reception spectrum 1 of the pulse-type radar device used has, for example, a Gaussian profile which is centred about a centre frequency and has falling edges. The signal which is periodic in the time domain gives rise to the illustrated, quasi-discrete, comb-like profile in the frequency domain. In this context, a frequency range 2 which is provided for the transmission of data for the purpose of communication is located in the region of the transmission/reception spectrum of the sensing signal.

In principle, the frequency range 2 may be located at any point on the transmission/reception spectrum of the radar device. In order to minimize disruption to the transmission of data by the sensing signal it has proven effective to attenuate the frequency components within the frequency range 2 in which spectral components of the sensing signal are located by using a notch filter which is tuned to the sensing signal.

The peripheral regions of the illustrated spectrum represent a particularly advantageous selection for the frequency range 2. This selection of the frequency range 2 sufficiently restricts mutual interference between the transmission of data and the radar device signals. The energy densities of a pulse-type radar device which are present in the radar device region are so small that mutual interference does not have a significant effect so that if appropriate it is also possible to dispense with the use of a notch filter. As a result it is particularly easy to ensure that at the same time the radar receiver and transmitter and further components of the system according to the invention can be used both for sensing and for transmitting data. In particular this also provides the possibility of permanently setting the data transmission part of the device to the ready-to-receive mode and the interference caused by the sensing mode of the radar device does not constitute any significant adverse influence on the transmission of data. Conversely, the sensitivity of the radar device receiver which is used for sensing in the described peripheral regions is so low that the sensing signal can only be subjected to a small or negligible amount of interference by the communication signal.

Of course, both alternatives of the individual radar device according to the invention can also be operated independently of one another, i.e. use in a pure data transmission mode or in a pure sensing mode is also possible.

One particularly suitable frequency range for the transmission of data by the radar system according to the invention is the region of the upper and lower 10%, in particular 5%, of the transmission/reception spectrum of the radar device used, as illustrated in FIG. 1. As a result of the spectral energy densities of the sensing signal which are particularly low in this range mutual interference between the sensing and data transmission operations is particularly small.

It has proven particularly effective to divide the frequency range used for the transmission of data into individual frequency bands. In this context it is possible, as illustrated in FIG. 2, to provide, for example, the frequency band 3, 4, 5 for emergency data, log data or communications data. The frequency bands here can be selected so as to adjoin one another or even overlap one another while being separated by unused frequency ranges.

The emergency channel with, for example, the assigned frequency band 3 is typically used to transmit emergency instructions using the location, time or other accident data information. The emission of emergency data can be triggered, for example, by particular events such as, for example, the triggering of air bags or seat belt pretensioners. Log data is used to organize the transmission of data. It uses, for example, the frequency band 4 and comprises, inter alia, data about the coordination of the channel access operations between the communication parties. In this context, the log data can be used to solve in particular what is referred to as the hidden station problem. The hidden station problem occurs if two transmitting stations are so far apart from one another that they cannot reach each other directly and thus cannot coordinate the channel access, but the signals of the two transmitters are simultaneously superimposing data at a third station. As a result, the reception at the third station is prohibited. As a result, for example, of a suitable closed-loop control of the transmission power of this channel it is possible to avoid this problem.

Communications data (for example in the frequency band 5) may be, for example, audio data or video data or else ASCII texts in the HTML format for transmitting web pages from the Internet and the implementation of voice communication from vehicle to vehicle is also conceivable.

The transmission rate which is necessary for the transmission of emergency data is only a few kbit and as a result amplitude modulation is possible as the modulation method for the emergency channel. A high data transmission rate and thus bandwidth are typically necessary to transmit communications data. The communications channel typically takes up a data rate of approximately 1 Mbit. A suitable modulation method for the associated data transmission is in particular the PSK modulation method with its different variants; further, in particular digital types of modulation such as, for example, FSK are also possible, and the same applies to the log channel.

One advantageous variant of the system according to the invention consists in conceiving it exclusively as a radar device signal receiver for the transmission of communications data, which receiver receives a communications data signal in a radar device signal of a radar system according to the invention and feeds it to a demodulation means; it is conceivable here to provide, for example, such a system as a retrofit set for passive network users which can also make advantageous use of the supplied data and information.

Conversely it is also advantageous to implement a radar device transmitter which simultaneously emits a broadband signal for sensing and a communications data signal in the peripheral region of the transmission spectrum of the broadband signal; possible applications for this are, for example, the use as a fixed information system at locations with poor visibility or as an information service about commercial services available in the direct surroundings, for example hotel accommodation, restaurants etc.

The additional data transmission functionality which is provided by the system according to the invention also permits a cooperative radar system to be implemented which is composed of the individual inventive radar systems of various vehicles. In this context, the ambient data which is acquired from the individual systems of the vehicles is fed to a means for carrying out parallel or combined evaluation and the range of the system is as a result increased in this way. For example information about obstacles which lie far outside the range of the vehicle's on-board radar system can be made available by the transmissions of other vehicles. As a result, it is possible to acquire knowledge about the traffic situation in regions which lie far outside the typical 20 m range of the close-range radar device. For example, this variant permits the driver of a vehicle to be provided with information about objects in the regions not covered by his own radar system, for example behind humps or at junctions, as a result of which vehicle safety is increased.

The described system is advantageously integrated into vehicles during their manufacture so that possibly occurring requirements relating to displays or operator control elements can be allowed for at an early point and the vehicle which is equipped with the inventive system meets high safety and comfort standards.

The method according to the invention for simultaneously sensing and transmitting communications data by means of a radar system which is operated in the pulsed mode and in which an end region of the transmission/reception spectrum of the sensing signal is used for the frequency range which is provided for the transmission of data brings about a significant overall improvement in traffic safety. Furthermore, it is thus easily possible to implement expanded possibilities for the provision of information and communication between individual road users.

1-11. (canceled)

12. A radar system, comprising:
at least one radar device having a sensor and a transmitter configured to transmit data, wherein the sensor and the transmitter are simultaneously operable for a communication.

13. The radar system as recited in claim 12, wherein the at least one radar device is a pulse-type radar device having a predefined transmission/reception spectrum with a transmission frequency range for the transmission of data and having a notch filter configured to selectively attenuate frequency subranges containing spectral components of a sensing signal within the transmission frequency range.

14. The radar system as recited in claim 12, wherein the at least one radar device is a pulse-type radar device having a predefined transmission/reception spectrum, a transmission frequency range provided for the transmission of data being in a peripheral region of the predefined transmission/reception spectrum.

15. The radar system as recited in claim 14, wherein the peripheral region includes no more than the upper and lower 10% of the transmission/reception spectrum.

16. The radar system as recited in claim 13, wherein the transmission frequency range includes a plurality of individual frequency bands, each for the transmission of data from a different data class.

17. The radar system as recited in claim 16, wherein the different data classes include at least one of emergency data, log data and communications data.

18. The radar system as recited in claim 12, wherein the at least transmitter provides amplitude modulation for the transmission of emergency data, and provides PSK types of modulation for the transmission of communications data and log data.

19. The radar system as recited in claim 12, wherein the radar system is for a motor vehicle.

20. A radar signal receiver configured to receive a communications data signal and feeding the communications data signal to a demodulation device, wherein the communications data signal is in a radar signal of a radar system according to claim 12.

21. A radar transmitter comprising:
an element configured to simultaneously emit a broadband signal for sensing and a communications data signal, wherein the broadband has having a transmission/reception spectrum with a peripheral region, and the communications data signal is in a peripheral region of a of the broadband signal.

22. A cooperative radar device system comprising a plurality of radar systems as recited in claim 12, wherein each of the plurality of radar systems is configured to sense its respective surroundings and simultaneously exchange data with another of the plurality of radar systems.

23. A vehicle having a radar system as recited in claim 12.

24. A method for sensing and transmitting data using a radar system having at least one radar device, the method comprising:
sensing and transmitting data simultaneously using the at least one radar device in a pulsed mode, wherein the transmitting of data is performed using a frequency range in a peripheral region of a transmission/reception spectrum of the sensing signal.
